(19) United States
(12) Patent Application Publication
(10) Pub. No.: US 2025/0139935 A1
(43) Pub. Date: May 1, 2025

(54) DETECTION METHOD AND SYSTEM FOR KEYPOINTS OF VIDEO IMAGE, DEVICE, AND STORAGE MEDIUM

(71) Applicant: AMLOGIC (SHANGHAI) CO., LTD, Shanghai (CN)

(72) Inventor: Ping JI, Shanghai (CN)

(21) Appl. No.: 18/816,333

(22) Filed: Aug. 27, 2024

(30) Foreign Application Priority Data
Nov. 1, 2023 (CN) 202311444736.3

(51) Int. Cl. G06V 10/50; G06V 10/26; G06V 10/96; G06V 20/40

(52) U.S. Cl. CPC G06V 10/50; G06V 10/26; G06V 10/96; G06V 20/46

(57) ABSTRACT

Disclosed are a detection method and system for keypoints of a video image, a device, and a storage medium. The detection method includes: acquiring a current video image; dividing the current video image into a plurality of blocks; and acquiring keypoints from each block in sequence; where the acquiring keypoints includes: generating initial keypoints of the block; and extracting the initial keypoints in combination with a keypoint acquisition condition in a previous video image, so as to acquire the keypoints of the block. The disclosure detects the keypoints of the current video image accurately.

### TECHNICAL FIELD

Embodiments of the disclosure relate to the technical field of image processing, and in particular to a detection method and system for keypoints of a video image, a device, and a storage medium.

### BACKGROUND

An image matching algorithm, an essential step in computer vision, is applied to unmanned aerial vehicle visual navigation, target detection and tracking, etc. in a wide range. The image matching algorithm is generally divided into a region-based image matching algorithm and a feature-based matching algorithm. The feature-based matching algorithm has become a hot research topic because of its small computation amount and good robustness. Feature extraction is a crucial step in the feature matching algorithm, and thus directly affects a success rate of image matching.

Common feature extraction algorithms include a Scale-invariant Feature Transform (SIFT) algorithm, a Speeded-up Robust Features (SURF) algorithm, and an ORB (Oriented FAST (Features from Accelerated Segment Test) and rotated BRIEF (Binary Robust Independent Elementary Features (BRIEF)) algorithm. SIFT has desirable discrimination, but high complexity and a large computation amount. The SURF algorithm has accurate parameter estimation and a small computation amount, while only a small number of matching point pairs are obtained. An ORB image feature extraction algorithm employs FAST to compute crucial points, and thus has the highest operation speed and occupies the smallest storage space, with a computation time being one percent of that of SIFT and one tenth of SURF approximately. However, the ORB image feature extraction algorithm has robustness inferior to that of SIFT, and has no scale invariance, leading to mismatch between images.

With FAST 9-16 employed to extract keypoints, the majority of existing ORB algorithms have a high computation speed, but will detect some edge points mistakenly, resulting in existence of some false corner points. In consequence, a matching effect is hindered directly, and mismatch is caused. Moreover, since features are extracted from an entire image, keypoints in a texture-sufficient region are too concentrated, but no keypoint is extracted from a texture-deficient region. The keypoints are distributed unevenly, which indirectly affects the success rate of image matching.

### SUMMARY

A problem to be solved in embodiments of the disclosure is to provide a detection method and system for keypoints of a video image, a device, and a storage medium, so as to accurately detect keypoints of a current video image.

To solve the above problem, a detection method for keypoints of a video image is provided in an embodiment of the disclosure. The detection method includes: acquiring a current video image; dividing the current video image into a plurality of blocks; and acquiring keypoints from each block in sequence; where the acquiring keypoints includes: generating initial keypoints of the block; and extracting the initial keypoints in combination with a keypoint acquisition condition in a previous video image, so as to acquire the keypoints of the block.

Correspondingly, a detection system for keypoints of a video image is provided in an embodiment of the disclosure. The detection system includes: a video image acquisition module configured to acquire a current video image; a division module configured to divide the current video image into a plurality of blocks; and a keypoint acquisition module configured to acquire keypoints from each block in sequence; where the keypoint acquisition module includes: an initial keypoint generation unit configured to generate initial keypoints of the block; and a keypoint extraction unit configured to extract the initial keypoints in combination with a keypoint acquisition condition in a previous video image, so as to acquire the keypoints of the block.

Correspondingly, a device is further provided in an embodiment of the disclosure. The device includes at least one memory and at least one processor, where the memory stores one or more computer instructions, and the one or more computer instructions are executed by the processor to implement the detection method for keypoints of a video image according to the embodiment of the disclosure.

Correspondingly, a storage medium is further provided in an embodiment of the disclosure. The storage medium stores one or more computer instructions, where the one or more computer instructions are configured to implement the detection method for keypoints of a video image according to the embodiment of the disclosure.

Compared with the prior art, the technical solutions in the embodiments of the disclosure have the advantages as follows:

In the detection method for keypoints of a video image according to the embodiment of the disclosure, the acquiring keypoints includes: generating the initial keypoints of the block; and extracting the initial keypoints in combination with the keypoint acquisition condition in the previous video image, so as to acquire the keypoints of the block. In the embodiment of the disclosure, in a video image sequence, two adjacent video images have a high correlation. Therefore, in a case of the extracting the initial keypoints in combination with a keypoint acquisition condition in a previous video image, so as to acquire the keypoints of the block, extraction of the initial keypoints is processed in real time according to an actual situation of the video image, so as to acquire the keypoints matching an actual image feature condition of the video image. Accordingly, the keypoints of the current video image are detected accurately.

### BRIEF DESCRIPTION OF THE DRAWINGS

FIG. 1 is a flowchart in an embodiment of a detection method for keypoints of a video image according to the disclosure;

FIGS. 2-7 are schematic diagrams corresponding to all steps in an embodiment of a detection method for keypoints of a video image according to the disclosure;

FIGS. 8-9 are functional block diagrams in an embodiment of a detection system for keypoints of a video image according to the disclosure; and

FIG. 10 is a structural diagram of hardware in an embodiment of a device according to the disclosure.

### DETAILED DESCRIPTION

It can be seen from the background art that most images are stored in a computer in a format of red-green-blue (RGB). It is difficult to accurately find the same object from a plurality of video images only through a pixel value of the image. The primary reason lies in that the pixel value itself of the image is highly susceptible to changes in illumination during shooting. Moreover, when an angle of view for shooting changes (such as rotation and translation), a pixel value of the same object will also change. Therefore, it is necessary to find a feature that can keep stable when a camera rotates or translates, and illumination changes, so as to identify these objects. Finally, the same object is found from different video images according to a feature having strong robustness.

In view of the above, computer vision researchers have designed various keypoints having high robustness and not varying with a distance of shooting, rotation of the camera, and change in illumination. For example, common feature extraction algorithms include an SIFT algorithm, an SURF algorithm, and an ORB algorithm.

Although having a high processing speed and desirable real-time performance, a conventional ORB algorithm still has the problems as follows: keypoints finally extracted are likely to be concentrated in a texture-sufficient region or feature-strong region, while few or no keypoints exist in a texture-deficient region lacking features. In consequence, some keypoints in the texture-sufficient region are useless, and one keypoint can be enough to clearly express a small region, so that most remaining keypoints are redundant. However, the texture-deficient region lacks a feature to describe information of the block. Globally, all the keypoints are distributed unevenly.

To solve the technical problem, a detection method for keypoints of a video image is provided in an embodiment of the disclosure. With reference to FIG. 1, a flowchart in an embodiment of a detection method for keypoints of a video image according to the disclosure is shown.

In the embodiment, the detection method for keypoints of a video image includes:
S1: a current video image is acquired;
S2: the current video image is divided into a plurality of blocks; and
S3: keypoints are acquired from each block in sequence.
S3 that keypoints are acquired includes:
S31: initial keypoints of the block are generated; and
S32: the initial keypoints are extracted in combination with a keypoint acquisition condition in a previous video image, so as to acquire the keypoints of the block.

In the embodiment of the disclosure, in a video image sequence, two adjacent video images have a high correlation. Therefore, in a case that the initial keypoints are extracted in combination with a keypoint acquisition condition in a previous video image, so as to acquire the keypoints of the block, extraction of the initial keypoints is processed in real time according to an actual situation of the video image, so as to acquire the keypoints matching an actual image feature condition of the video image. Accordingly, the keypoints of the current video image are detected accurately.

To make the above objectives, features, and advantages in the embodiment of the disclosure more obvious and understandable, particular embodiments of the disclosure are described in detail below in conjunction with the accompanying drawings.

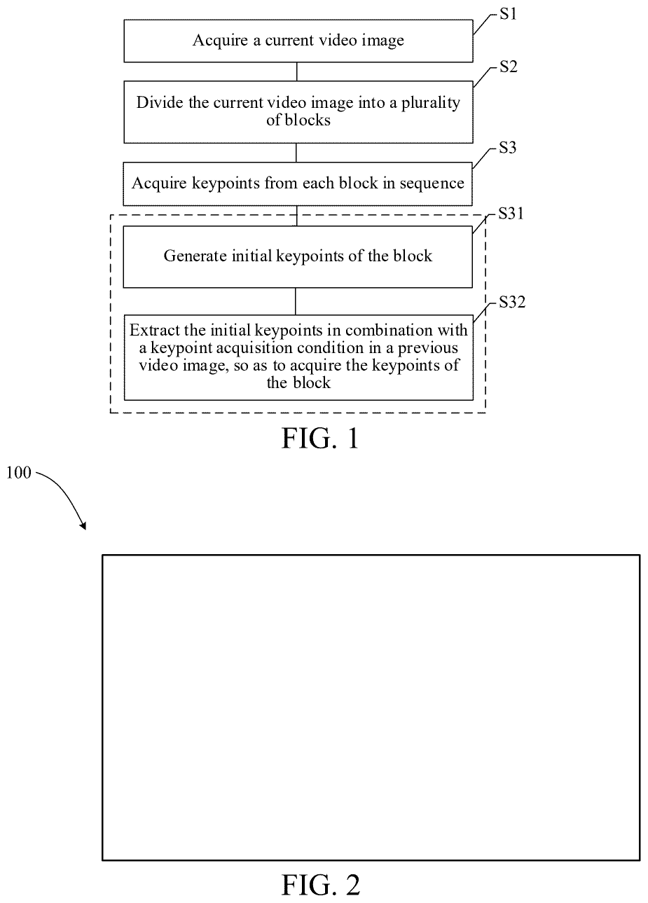

FIGS. 2-7 are schematic diagrams corresponding to all steps in an embodiment of a detection method for keypoints of a video image according to the disclosure.

With reference to FIG. 2, S1 that a current video image 100 is acquired is executed.

In computer vision applications, the primary problem is to efficiently and accurately identify the same object from a plurality of video images in a video.

Specifically, by selecting a representative region (a region having strong features) from the video image, the same objects may be better matched between the plurality of video images, for example, the keypoints, strong edges, line features, etc. in the video images. A distinctiveness image algorithm for a corner point, one representative feature in the video image, is comprehensible and intuitive. Therefore, in most computer vision processing, the corner point is extracted as a feature, also known as a “keypoint”. The keypoints are employed to perform matching between the video images, for example, motion image anti-shake, panoramic image stitching, and visual SLAM.

In the embodiment, the current video image 100 is acquired and configured to acquire the keypoints from the current video image 100 for image capturing.

In the embodiment, in a case that a current video image 100 is acquired, the video image 100 is set to have a preset number of keypoints.

The video image 100 is set to have the preset number of keypoints, so as to be taken as an evaluation criterion for determining an intra-frame computation mode for the keypoints subsequently.

It should be noted that in the embodiment, the preset number of keypoints of the current video image 100 is set according to a total number of keypoints finally acquired from the previous video image.

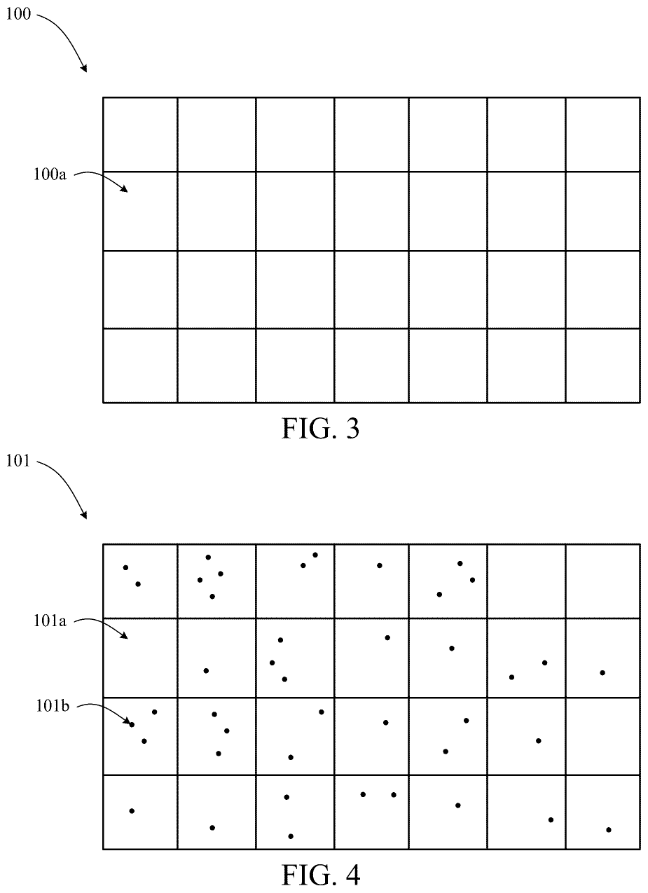

With reference to FIG. 3, S2 that the current video image 100 is divided into a plurality of blocks 100a is executed.

The plurality of blocks 100a are configured for subsequent keypoint extraction. Compared with directly extracting keypoints from an entire current video image subsequently, in the embodiment, the current video image 100 is first divided into the plurality of blocks 100a, and the keypoints are extracted from each block 100a subsequently. Therefore, the keypoints are extracted from the current video image 100 globally as much as possible. Moreover, a keypoint extraction condition of each block 100a is adjusted. For example, after adjustment, some keypoints may also be extracted from a texture-deficient region of the video image 100 to describe the region.

In the embodiment, in a case that the current video image 100 is divided into a plurality of blocks 100a, a size of each block 100a divided is set according to a size of the current video image 100.

It should be noted that the size of each block 100a divided should not be too large or too small. If the size of the plurality of blocks 100a divided is set to be too small, complexity of detecting each block 100a is increased, and the current video image 100 is likely to be divided too densely, so that an excessive computation amount is added, detection efficiency is reduced, and a detection cost is increased. If the size of the plurality of blocks 100a divided is set to be too large, it is likely to cause serious unevenness when the keypoints are extracted from the block 100a subsequently, so that the accuracy of extracting the keypoints from the current video image 100 is affected. In view of the above, in the embodiment, the size of each block 100a divided is set according to the size of the current video image 100.

As an example, for an image larger than 1080P, the size of 30*30 of the block 100a is too small, which will cause an aperture effect, and it is required to set the size of the block 100a to be greater than 30*30. For an image of 720P, the size of 60*60 of the block 100a is too large, which is likely to cause unevenness within the block, leading to uneven distribution of all the keypoints, and it is required to set the size of the block 100a to be smaller than 60*60. Therefore, the size of the block 100a is required to be adjusted according to the size of the video image.

In the embodiment, in a case that the current video image 100 is divided into a plurality of blocks 100a, the video image 100 is evenly divided into the plurality of blocks 100a, so that the keypoints are evenly extracted from the block 100a subsequently.

It should be noted that in the embodiment, the plurality of blocks 100a divided from the current video image 100 do not overlap.

With reference to FIGS. 4-7, S3 that keypoints 100b are acquired from each block 100a in sequence is executed.

It should be noted that the step that keypoints 100b are acquired from each block 100a in sequence indicates a step that in a designated direction, the keypoints 100b are acquired from one block 100a first, and then the keypoints 100a are acquired from a next block 100a. In the designated direction, transverse row scanning may be performed. After keypoints 100b are acquired from one row of blocks 100a, a next row of blocks 100a are scanned, until the keypoints 100b are acquired from all blocks 100a.

The keypoints 100b are acquired from each block 100a. The keypoints 100b are taken as representative points in the video image and configured for matching of the same objects between the plurality of video images subsequently.

Specifically, the common keypoint algorithms include an SIFT algorithm, an SURF algorithm, an ORB algorithm, etc. The keypoint algorithm of the video image consists of keypoint location (Keypoint Location) and descriptor generation (Descriptor Generation). The keypoint location indicates that a position (i.e. coordinates) of the keypoint in the video image is acquired from the video image through a definition of the keypoint algorithm, and some crucial information having a direction and scale may also be acquired. The descriptor generation indicates that a descriptor is generated for each keypoint located. A result of the descriptor is generally a multidimensional vector designed according to an artificial algorithm. The descriptor is configured to describe information of pixels around the keypoint, which is equivalent to provision of an independent identifier for the keypoint, so as to identify the keypoint or distinguish between different keypoints. During keypoint matching, the descriptors are compared with each other for matching according to keypoint descriptors generated according to positions of the keypoints acquired.

In the embodiment, extracting the keypoints through the ORB algorithm is described as an example.

S3 that keypoints 100b are acquired includes: S31 that initial keypoints of the block 100a are generated is executed.

The initial keypoints of the block 100a are generated and configured to extract final keypoints from the block 100a subsequently.

In the embodiment, the initial keypoints of the block 100a are generated through an FAST algorithm, where a detection threshold in the FAST algorithm includes a high threshold and a low threshold.

The features from accelerated segment test (Features from accelerated segment test, FAST) algorithm is an algorithm configured to detect the corner point. The principle of the algorithm is to take a detection point from an image and determine whether the detection point is the corner point through pixel points in a neighborhood around the point that serves as a center of a circle. In other words, if a particular number of pixels around one pixel have pixel values different from that of the point, the point is deemed as the corner point, i.e., the initial keypoint.

It should be noted that the detection threshold in the FAST algorithm includes the high threshold and the low threshold, which indicates that the detection threshold in the FAST algorithm includes two thresholds, and a larger value and a smaller value of the two thresholds are the high threshold and the low threshold respectively.

Specifically, in the embodiment, the block 100a is detected through the FAST algorithm, and the pixel point having a difference between gray values of various pixel points around the pixel point and a gray value of the pixel point greater than or equal to the detection threshold is generated as the initial keypoint. Correspondingly, the detection threshold is a gray difference, the high threshold means a larger gray difference, and the low threshold means a smaller gray difference.

The initial keypoints of the block 100a are generated through the FAST algorithm, where the detection threshold in the FAST algorithm includes the high threshold and the low threshold. Therefore, when not being generated from the texture-deficient region of the video image 100 based on the high threshold, the initial keypoints may still be generated based on the low threshold. Generation of the initial keypoints correspondingly affects a number and location of the final keypoints 100b. In extraction of the keypoints 100b, if the keypoints 100b extracted are concentrated in the texture-sufficient region or feature-strong region only, for one block 100a, one keypoint 100b may be enough to clearly express one region, and remaining keypoints 100b are redundant, so that unnecessary waste and cost increase are likely to be caused. However, for the texture-deficient region that lacks keypoints 100b to describe information of the block 100a, globally, all the keypoints 100b are distributed unevenly. Therefore, the detection threshold in the FAST algorithm includes the high threshold and the low threshold. The situation that the keypoints 100b finally extracted are concentrated in the texture-sufficient region or feature-strong region, while few or no keypoint 100b exists in the texture-deficient region lacking features is avoided as much as possible accordingly. Extraction of the keypoints 100b from the texture-deficient region is significantly improved, so that the keypoints 100b of the current video image 100 are distributed more evenly.

Specifically, in the embodiment, the step that the initial keypoints of the block 100a are generated through an FAST algorithm includes: simultaneous detection is performed on the block 100a based on the high threshold and the low threshold.

It should be noted that the simultaneous detection is performed on the block 100a based on the high threshold and the low threshold, which indicates that the block 100a is detected based on the high threshold and the low threshold simultaneously.

In a case that simultaneous detection is performed on the block 100a based on the high threshold and the low threshold, it is not required to detect all the blocks 100a twice. Each block 100a is detected based on the high threshold and the low threshold by detecting all the blocks 100a only once. Therefore, efficiency of generating the initial keypoints is improved.

In the embodiment, in a case that the initial keypoint are detected based on the high threshold, detection based on the low threshold is stopped, and the initial keypoints detected based on the high threshold are acquired.

In a case that the initial keypoints are detected based on the high threshold, the detection based on the low threshold is stopped. Therefore, a step of repeatedly reading a content of the same block 100a is avoided, unnecessary computation is reduced in real time, detection efficiency is improved, and a detection cost is reduced.

In the embodiment, in a case that no initial keypoints are detected based on the high threshold, and the initial keypoints are detected based on the low threshold, the initial keypoints detected based on the low threshold are acquired.

In a case that no initial keypoints are detected based on the high threshold, and the initial keypoints are detected based on the low threshold, in other words, in a case that the block 100a has deficient texture, detection based on the low threshold may still be performed in real time to acquire the initial keypoints.

In the embodiment, in a case that no initial keypoints are detected based on the high threshold and the low threshold, the step that keypoints 100b are acquired from the block 100a is skipped.

In a case that no initial keypoints are detected based on the high threshold and the low threshold, in other words, in a case that the feature of the block 100b is too unapparent, it is not required to extract the keypoints 100b, so that the step that keypoints 100b are acquired from the block 100a is skipped directly, saving on a computation effort.

S3 that keypoints 100b are acquired further includes: S32 that the initial keypoints are extracted in combination with a keypoint 101b acquisition condition in a previous video image 101, so as to acquire the keypoints 100b of the block 100a is executed.

The step that the initial keypoints are extracted in combination with a keypoint 101b acquisition condition in a previous video image 101, so as to acquire the keypoints 100b of the block 100a indicates an inter-frame keypoint allocation algorithm.

In the embodiment, in the video image sequence, two adjacent video images have a high correlation. Therefore, in a case that the initial keypoints are extracted in combination with a keypoint 101b acquisition condition in a previous video image 101, so as to acquire the keypoints 100b of the block 100a, extraction of the initial keypoints is processed in real time according to an actual situation of the video image, so as to acquire the keypoints 100a matching an actual image feature condition of the video image. Accordingly, the keypoints 100a of the current video image 100 are detected accurately.

In the embodiment, the step that the initial keypoints are extracted in combination with a keypoint 101b acquisition condition in a previous video image 101, so as to acquire the keypoints 100b of the block 100a includes: according to keypoint 101b acquisition information of a block 101a in the previous video image 101 corresponding to a current block 100a, an estimated number of keypoints 100b of the current block 100a is acquired.

The estimated number of keypoints 100b of the current block 100a is acquired and taken as a reference for acquiring actual keypoints 100b from the current block 100a. Moreover, according to the keypoint 101b acquisition information of the block 101a in the previous video image 101 corresponding to the current block 100a, the estimated number of keypoints 100a matching the actual image feature condition of the video image is acquired according to the actual situation of the video image.

Specifically, with reference to FIG. 4. The step that according to keypoint 101b acquisition information of a block 101a in the previous video image 101 corresponding to a current block 100a, an estimated number of keypoints 100b of the current block 100a is acquired includes: the block 101a in the previous video image 101 corresponding to the current block is acquired as a reference block.

The reference block is taken as a basis for acquiring the estimated number of keypoints 100b of the current block 100a.

In the embodiment, a block in a neighborhood of the reference block is acquired from the previous video image 101 as a surrounding block.

The surrounding block and the reference block are jointly taken as the basis for acquiring the estimated number of keypoints 100b of the current block 100a.

In the embodiment, in a case that a block 101a in a neighborhood of the reference block is acquired from the previous video image 101 as a surrounding block, a neighborhood range of the reference block is set according to a global motion vector of the previous video image 101, where a size of the global motion vector is directly proportional to a size of the neighborhood range.

It should be noted that the size of the global motion vector is directly proportional to the size of the neighborhood range, which indicates that the greater the global motion vector is, the wider the neighborhood range set is, and the smaller the global motion vector is, the narrower the neighborhood range set is.

The global motion vector (Global Motion Vector, GMV) indicates a motion speed of the previous video image 101. The greater the global motion vector is, the higher the motion speed of the previous video image 101 is, the greater the image change is, and reference may be made to a wider range. The smaller the global motion vector is, the lower the motion speed of the previous video image 101 is, the smaller the image change is, and reference may be made to a narrower range. Therefore, the size of the global motion vector is directly proportional to the size of the neighborhood range.

As an example, in a case of a large global motion vector, 24 surrounding blocks 101a in the neighborhood of the reference block are selected as the reference blocks. In a case of a small global motion vector, 8 surrounding blocks 101a in the neighborhood of the reference block are selected as the reference blocks.

In the embodiment, the estimated number of keypoints 100b of the current block 100a is acquired in combination with keypoint acquisition information of the reference block and keypoint acquisition information of the surrounding block.

If there is a particular spatial correlation in the video image, the keypoint acquisition information of the surrounding block also affects the estimated number of keypoints 100b of the current block 100a. Therefore, the estimated number of keypoints 100b of the current block 100a is acquired in combination with the keypoint acquisition information of the reference block and the keypoint acquisition information of the surrounding block.

In the embodiment, the step that the estimated number of keypoints 100b of the current block 100a is acquired in combination with keypoint 101b acquisition information of the reference block and keypoint acquisition information of the surrounding block includes: the block 100a of the current video image 100 is graded in combination with the keypoint 101b acquisition information of the reference block and the keypoint acquisition information of the surrounding block, so as to obtain a grade corresponding to each block 100a, where each grade has a corresponding estimated number.

By grading the block 100a of the current video image 100, all the blocks 100a of the current video image 100 may be classified, blocks 100a having similar features may be divided into the same class, and the same estimated number may be assigned to the blocks 100a of the same class. Therefore, the estimated numbers of all the blocks 100a are acquired simultaneously, and it is not required to assign the estimated number to each block 100a separately. Accordingly, a number for assigning the corresponding estimated number to the block 100a is reduced, computation efficiency is improved, and a computation cost is reduced.

Correspondingly, in the embodiment, the estimated number of keypoints 100b of each block 100a is acquired according to the grade corresponding to each block 100a.

In the embodiment, the step that the estimated number of keypoints 100b of the current block 100a is acquired in combination with keypoint 101b acquisition information of the reference block and keypoint acquisition information of the surrounding block includes: a condition that whether the reference block has keypoints 101b is acquired as first information.

The condition that whether the reference block has keypoint 101b indicates a texture condition of the reference block, and a texture condition of the current block 100a of the current video image 100 may be fed back correspondingly.

In the embodiment, in a case that the initial keypoints of the reference block are generated through the FAST algorithm, a condition that whether the detection threshold is the high threshold or the low threshold is acquired as second information.

In a case that the initial keypoints of the reference block are generated through the FAST algorithm, the condition that whether the detection threshold is the high threshold or the low threshold further finely indicates the texture condition of the reference block. Correspondingly, the texture condition of the current block 100a of the current video image 100 may be further finely fed back.

In the embodiment, a condition that whether a number of the surrounding block having keypoints 101b is greater than or equal to a set threshold is acquired as third information.

The condition that whether the number of the surrounding block having keypoints 101b is greater than or equal to the set threshold is acquired, which indicates that some blocks 101a in the surrounding blocks may have no keypoints 101b, some blocks 101a have keypoints 101b, and whether the number of the surrounding blocks having keypoints 101b is greater than or equal to the set threshold is acquired.

The condition that whether a number of the surrounding block having keypoints 101b is greater than or equal to a set threshold indicates a texture distribution condition of the surrounding block. Correspondingly, a texture distribution condition around the current block 100a of the current video image 100 may be fed back.

In the embodiment, in a case that the condition that whether a number of the surrounding block having keypoints 101b is greater than or equal to a set threshold is acquired, the set threshold is half of a total number of the surrounding block.

The set threshold is half of the total number of the surrounding block. In other words, whether the number of the surrounding block having keypoints 101b exceeds half is acquired. If the number exceeds half, it indicates that the surrounding block has strong texture. If the number does not exceed half, it indicates that the surrounding block has deficient texture.

In the embodiment, the estimated number of keypoints 100b of the current block 100a is acquired in combination with the first information, the second information, and the third information.

The estimated number of keypoints 100b of the current block 100a is acquired in combination with the first information, the second information, and the third information. Therefore, all factors affecting distribution of the keypoints 100b of the current block 100a are comprehensively considered, so as to acquire the accurate estimated number of the keypoints 100b.

In the embodiment, a corresponding number of the initial keypoints are extracted according to the estimated number of keypoints 100b of the current block 100a as the keypoints 100b of the block 100a.

The corresponding number of the initial keypoints are extracted according to the estimated number of keypoints 100b of the current block 100a. Therefore, the keypoints 100b matching actual texture distribution of the current video image 100 are acquired.

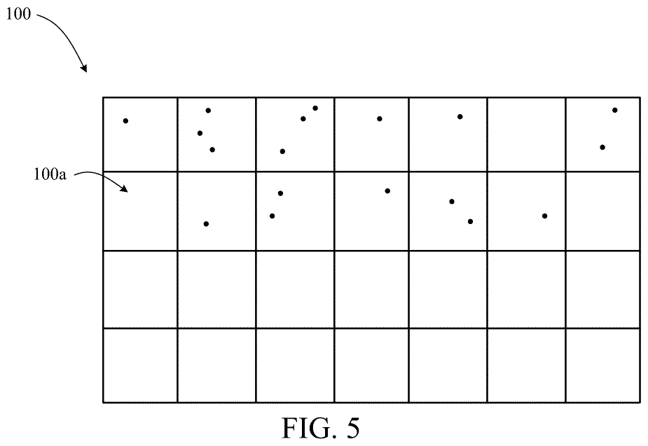

With reference to FIG. 5, the step that a corresponding number of the initial keypoints are extracted according to the estimated number of keypoints 100b of the current block 100a as the keypoints 100b of the block 100a includes: a keypoint 100b number adjustment value of the current block 100a is acquired according to a number of keypoints 100b of all blocks 100a before the current block 100a and the estimated number of keypoints 100b.

The step that a keypoint 100b number adjustment value of the current block 100a is acquired according to a number of keypoints 100b of all blocks 100a before the current block 100a and the estimated number of keypoints 100b indicates an intra-frame keypoint matching algorithm.

In a process of extracting the initial keypoints to acquire the keypoints 100a, if a number of initial keypoints actually produced from each block 100a may not match the estimated number of keypoints 100b, especially if the number of initial keypoints actually produced is less than the estimated number of keypoints 100b, it may be difficult to extract a sufficient number of initial keypoints from the block 100a as the keypoints 100b, so that the keypoints 100b of the current video image 100 are in deficit finally. Therefore, the keypoint 100b number adjustment value of the current block 100a is acquired according to the number of keypoints 100b of all the blocks 100a before the current block 100a and the estimated number of keypoints 100b, and is configured to adjust the number of keypoints 100b of the current block 100a and a number of keypoints of blocks 100a to be processed subsequently. Accordingly, a probability that the keypoints 100b of the current video image 100 are in deficit finally is reduced.

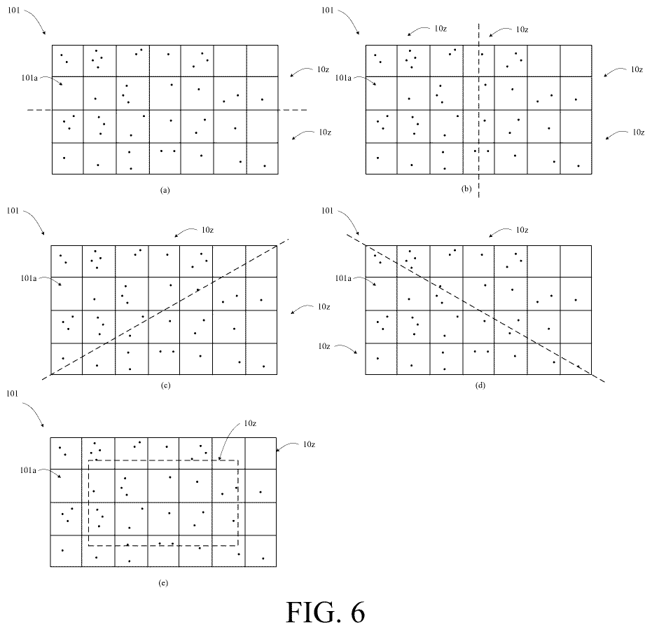

With reference to FIG. 6, the step that a keypoint 100b number adjustment value of the current block 100a is acquired according to a number of keypoints 100b of all blocks 100a before the current block 100a and the estimated number of keypoints 100b includes: a selection mode for acquiring the keypoint 100b number adjustment value of the current block 100a is set according to a keypoint 101b distribution condition of the previous video image 101, where the selection mode includes an even allocation mode or a greedy acquisition mode.

The keypoint 101b distribution condition of the previous video image 101 feeds back a keypoint 101b distribution condition of the current video image 100 to a certain extent. Accordingly, by setting the selection mode for acquiring the keypoint 100b number adjustment value of the current block 100a according to the keypoint 101b distribution condition of the previous video image 101, the selection mode conforming to the actual texture condition of the current video image 100 may be acquired.

The even allocation mode indicates that the adjustment value is evenly assigned to the current block 100a and other blocks 100a to be processed subsequently. The greedy acquisition mode indicates that for the current block 100a and other blocks 100a to be processed subsequently, a larger adjustment value is assigned to the block 100a having more sufficient texture, i.e., stronger features, and a smaller adjustment value is assigned to the block 100a having more deficient texture, i.e., weaker features.

Correspondingly, in the embodiment, the keypoint 100b number adjustment value of the current block 100a is acquired according to the selection mode.

In the embodiment, the step that a selection mode for acquiring the keypoint 100b number adjustment value of the current block 100a is set according to a keypoint 101b distribution condition of the previous video image 101 includes: whether the keypoints 101b of the previous video image 101 are distributed evenly is determined.

Whether the keypoints 101b of the previous frame video image 101 are distributed evenly indicates whether the keypoints 100b of the current video image 100 are distributed evenly. Therefore, the selection mode for acquiring the keypoint 100b number adjustment value of the current block 100a is set according to whether the keypoints 101b of the previous video image 101 are distributed evenly.

In the embodiment, the selection mode for acquiring the keypoint 100b number adjustment value of the current block 100a is set as the even allocation mode in a case that the keypoints 101b of the previous video image 101 are distributed evenly.

In a case that the keypoints 101b of the previous video image 101 are distributed evenly, it indicates that the keypoints 100b of the current video image 100 are distributed evenly, so that the number of the initial keypoints extracted may be adjusted evenly in the even allocation mode.

In the embodiment, the selection mode for acquiring the keypoint 100b number adjustment value of the current block 100a is set as the greedy acquisition mode otherwise (if the keypoints 101b of the previous video image 101 are distributed unevenly).

Otherwise, it indicates that the keypoints 100b of the current video image 100 are distributed unevenly, so that the greedy acquisition mode is employed to fill some regions where the keypoints 100b are distributed unevenly, and the number of the initial keypoints extracted may be adjusted evenly.

In the embodiment, the step that whether keypoints 101b of the previous video image 101 are distributed evenly is determined includes: the previous video image 101 is divided one or more times, and two sub-regions 10z having the same area are acquired during each division.

The previous video image 101 is divided one or more times, and the two sub-regions 10z having the same area are acquired during each division, so that all the sub-regions 10z have the same area. In the embodiment, even distribution indicates that numbers of keypoints 100b in all the sub-regions 10z are as same as possible.

As an example, as shown in FIG. 6, the previous video image 101 undergoes five divisions, including upper-lower even division shown in FIG. 6 (a), left-right even division shown in FIG. 6 (b), upper left-lower right even division shown in FIG. 6 (c), upper right-lower left even division shown in FIG. 6 (d), and inner circle-outer circle even division shown in FIG. 6 (e), so as to acquire ten sub-regions 10z having the same area.

In the embodiment, a variance of numbers of keypoints 101b in a plurality of sub-regions 10z acquired during all divisions is acquired.

As an example, a variance of numbers of keypoints 101b in the ten sub-regions 10z is acquired to indicate a degree of dispersion between the keypoints 101b in the ten sub-regions 10z and an average.

In the embodiment, the sum of the numbers of keypoints 101b in a plurality of sub-regions 10z acquired during all divisions is acquired.

As one example, the sum of the number of keypoints 101b in the ten sub-regions 10z is acquired.

In the embodiment, a ratio of the variance to the sum is acquired.

As an example, a ratio of the variance to the sum of the numbers of keypoints 101b in the ten sub-regions 10z is acquired to indicate a degree of evenness of the keypoints 101b in the ten sub-regions 10z.

It can be seen that the smaller the variance is, the greater the sum of the numbers of keypoints 101b in the plurality of sub-regions 10z is, the smaller the ratio of the variance to the sum is, and the more even the distribution of the keypoints 101b of the previous video image 101 is.

Correspondingly, in the embodiment, when the ratio of the variance to the sum is less than or equal to an evenness threshold, it is determined that the keypoints 101b of the previous video image 101 are distributed evenly. When the ratio of the variance to the sum is greater than an evenness threshold, it is determined that the keypoints 101b of the previous video image 101 are distributed unevenly.

In the embodiment, in a case that the selection mode for acquiring the keypoint 100b number adjustment value of the current block 100a is set as the even allocation mode, the step that the keypoint number adjustment value of the current block is acquired according to the selection mode includes: a difference between the sum of estimated numbers of keypoints 100b of all the blocks 100a before the current block 100a and the sum of the keypoints 100b is acquired as a deviation value.

In the process of extracting the initial keypoints to acquire the keypoints 100a, if the number of initial keypoints actually generated is less than the estimated number of keypoints 100b, it is difficult to extract a sufficient number of initial keypoints from the block 100a as the keypoints 100b, and the keypoints 100a of some blocks 100a before the current block 100a are in deficit. Therefore, the difference between the sum of the estimated numbers of keypoints 100b of all the blocks 100a before the current block 100a and the sum of the keypoints 100b, i.e. a total number of keypoints 100b in deficit of all the blocks 100a before the current block 100a is acquired and configured to be evenly allocated to the current block 100a and all the blocks 100a after the current block 100a. A pre-allocated solution is re-optimized dynamically within the frame according to an actual situation, so that the number of the initial keypoints extracted further satisfies demands.

In the embodiment, the number of the current block 100a and a block 110a number of all blocks 100a after the current block 100a are acquired.

The number of the current block 100a and the block 100a number of all blocks 100a after the current block 100a are acquired as the total number of the blocks to be evenly allocated the keypoints 100b in deficit of all the blocks 100a before the current block 100a.

In the embodiment, a ratio of the deviation value to the number of blocks 100a is taken as the keypoint 100b number adjustment value of the current block 100a.

With the ratio of the deviation value to the number of blocks 100a as the keypoint 100b number adjustment value of the current block 100a, all the blocks 100a after the current block 100a are adjusted evenly.

In the embodiment, in a case that the selection mode for acquiring the keypoint 100b number adjustment value of the current block 100a is set as the greedy acquisition mode, the step that the keypoint 100b number adjustment value of the current block 100a is acquired according to the selection mode includes: a difference between the sum of estimated numbers of keypoints 100b of all blocks 100a before the current block 100a and the sum of keypoints 100b is acquired as a deviation value.

The description of the deviation value is the same as that for the even allocation mode, which will not be repeated herein.

In the embodiment, with a ratio of the preset number to the number of the blocks 100a of the current video image 100 as a number threshold, a difference between the number threshold and the estimated number of keypoints 100b of the current block 100a is acquired as the keypoint 100b number adjustment value of the current block 100a in a case that the estimated number of keypoints 100b of the current block 100a is less than the number threshold, and the estimated number of keypoints 100b of the current block 100a is less than a number of the initial keypoints.

The ratio of the preset number to the number of the blocks 100a of the current video image 100 is a preset average number of keypoints 100b of each block 100a, i.e., the number threshold. In a case that the estimated number of keypoints 100b of the current block 100a is less than the number threshold, and the estimated number of keypoints 100b of the current block 100a is less than a number of the initial keypoints, it indicates that the current block 100a has apparent features, and there are initial keypoints left for selection. Therefore, a larger keypoint 100b adjustment value is allocated to the current block 100a as much as possible. Specifically, the difference between the number threshold and the estimated number of keypoints 100b of the current block 100a is acquired as the keypoint 100b number adjustment value of the current block 100a. Accordingly, the operation is simple and the allocation tends to be even.

In the embodiment, the keypoint 100b number adjustment value of the current block 100a is acquired as 0 in a case that the estimated number of keypoints 100b of the current block 100a is greater than or equal to the number threshold, and alternatively, the estimated number of keypoints 100b of the current block 100a is less than the number threshold, and the estimated number of keypoints 100b of the current block 100a is greater than or equal to a number of the initial keypoints.

In a case that the estimated number of keypoints 100b of the current block 100a is greater than or equal to the number threshold, it indicates that the features of the current block 100a are not sufficiently apparent to allow for allocation of more keypoints 100b, so that the keypoint 100b number adjustment value of the current block 100a is acquired as 0. Alternatively, in a case that the estimated number of keypoints 100b of the current block 100a is less than the number threshold, and the estimated number of keypoints 100b of the current block 100a is greater than or equal to a number of the initial keypoints, it indicates that the current block 100a has no initial keypoints left for selection, so that the keypoint 100b number adjustment value of the current block 100a is acquired as 0.

In the embodiment, a target number of keypoints 100b of the current block 100a is acquired in combination with the keypoints 100b number adjustment value and the estimated number of keypoints 100b of the current block 100a.

The number of the initial keypoints to be extracted from the current block 100a is adjusted in combination with the keypoint 100b number adjustment value and the estimated number of keypoints 100b of the current block 100a, so as to acquire the target number of keypoints 100b of the current block 100a. Therefore, the keypoints 100b of the current video image 100 are distributed more evenly.

Specifically, in the embodiment, the step that a target number of keypoints 100b of the current block 100a is acquired in combination with the keypoints 100b number adjustment value and the estimated number of keypoints 100b of the current block 100a includes: the sum of the keypoint 100b number adjustment value and the estimated number of keypoints 100b of the current block 100a is acquired as the target number of keypoints 100b of the current block 100a.

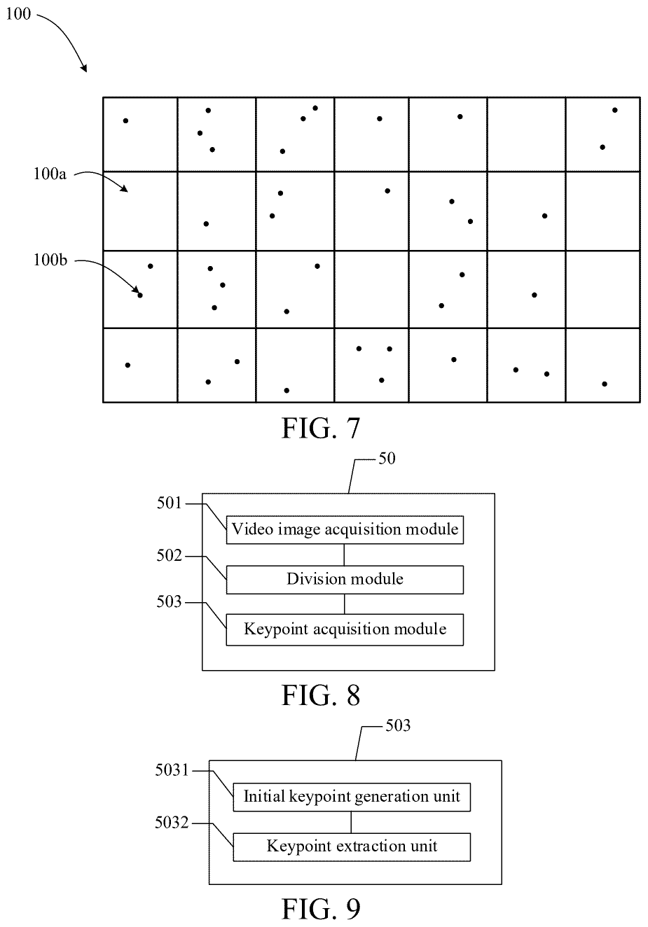

With reference to FIG. 7, the initial keypoints are extracted as the keypoints 100b of the block 100a according to the target number.

The initial keypoints are extracted as the keypoints 100b of the block 100a according to the target number, and the keypoints 100b distributed evenly of the current video image 100 may be acquired.

In the embodiment, the step that the initial keypoints are extracted as the keypoints 100b of the block 100a according to the target number includes: the initial keypoints in a number equal to the target number are extracted as the keypoints 100b of the block 100a in a case that the target number of keypoints 100b of the current block 100a is less than or equal to the number of the initial keypoints.

The initial keypoints in a number equal to the target number are extracted in a case that the target number of keypoints 100b of the current block 100a is less than or equal to the number of the initial keypoints, so as to satisfy detection demands.

In the embodiment, all initial keypoints are extracted as the keypoints 100b of the block 100a in a case that the target number of keypoints 100b of the current block 100a is greater than the number of the initial keypoints.

In a case that the target number of keypoints 100b of the current block 100a is greater than the number of the initial keypoints, the current block 100a has no initial keypoints left for selection. Therefore, all the initial keypoints are extracted as the keypoints 100b of the block 100a.

Correspondingly, the disclosure further provides a detection system for keypoints of a video image. FIGS. 8-9 are functional block diagrams in an embodiment of a detection system for keypoints of a video image according to the disclosure.

In the embodiment, the detection system 50 for keypoints of a video image includes: a video image acquisition module 501 configured to acquire a current video image; a division module 502 configured to divide the current video image into a plurality of blocks; and a keypoint acquisition module 503 configured to acquire keypoints from each block in sequence; where the keypoint acquisition module 503 includes: an initial keypoint generation unit 5031 configured to generate initial keypoints of the block; and a keypoint extraction unit 5032 configured to extract the initial keypoints in combination with a keypoint acquisition condition in a previous video image, so as to acquire the keypoints of the block.

The video image acquisition module 501 is configured to acquire the current video image.

In computer vision applications, the primary problem is to efficiently and accurately identify the same object from a plurality of video images in a video.

Specifically, by selecting a representative region (a region having strong features) from the video image, the same objects may be better matched between the plurality of video images, for example, the keypoints, strong edges, line features, etc. in the video images. A distinctiveness image algorithm for a corner point, one representative feature in the video image, is comprehensible and intuitive. Therefore, in most computer vision processing, the corner point is extracted as a feature, also known as a “keypoint”. The keypoints are employed to perform matching between the video images, for example, motion image anti-shake, panoramic image stitching, and visual SLAM.

In the embodiment, the current video image is acquired and configured to acquire the keypoints from the current video image for image capturing.

In the embodiment, in a case that a current video image is acquired, the video image is set to have a preset number of keypoints.

The video image is set to have the preset number of keypoints, so as to be taken as an evaluation criterion for determining an intra-frame computation mode for the keypoints subsequently.

It should be noted that in the embodiment, the preset number of keypoints of the current video image is set according to a total number of keypoints finally acquired from the previous video image.

The division module 502 is configured to divide the current video image into the plurality of blocks.

The plurality of blocks are configured for subsequent keypoint extraction. Compared with directly extracting keypoints from an entire current video image subsequently, in the embodiment, the current video image is first divided into the plurality of blocks, and the keypoints are extracted from each block subsequently. Therefore, the keypoints are extracted from the current video image globally as much as possible. Moreover, a keypoint extraction condition of each block is adjusted. For example, after adjustment, some keypoints may also be extracted from a texture-deficient region of the video image to describe the region.

In the embodiment, in a case that the current video image is divided into a plurality of blocks, a size of each block divided is set according to a size of the current video image.

It should be noted that the size of each block divided should not be too large or too small. If the size of the plurality of blocks divided is set to be too small, complexity of detecting each block is increased, and the current video image is likely to be divided too densely, so that an excessive computation amount is added, detection efficiency is reduced, and a detection cost is increased. If the size of the plurality of blocks divided is set to be too large, it is likely to cause serious unevenness when the keypoints are extracted from the block subsequently, so that the accuracy of extracting the keypoints from the current video image is affected. In view of the above, in the embodiment, the size of each block divided is set according to the size of the current video image.

As an example, for an image larger than 1080P, the size of 30*30 of the block is too small, which will cause an aperture effect, and it is required to set the size of the block to be greater than 30*30. For an image of 720P, the size of 60*60 of the block is too large, which is likely to cause unevenness within the block, leading to uneven distribution of all the keypoints, and it is required to set the size of the block to be smaller than 60*60. Therefore, the size of the block is required to be adjusted according to the size of the video image.

In the embodiment, in a case that the current video image is divided into a plurality of blocks, the video image is evenly divided into the plurality of blocks, so that the keypoints are evenly extracted from the block subsequently.

It should be noted that in the embodiment, the plurality of blocks divided from the current video image do not overlap.

The keypoint acquisition module 503 is configured to acquire the keypoints from each block in sequence.

It should be noted that the step that keypoints are acquired from each block in sequence indicates a step that in a designated direction, the keypoints are acquired from one block first, and then the keypoints are acquired from a next block. In the designated direction, transverse row scanning may be performed. After keypoints are acquired from one row of blocks, a next row of blocks are scanned, until the keypoints are acquired from all blocks.

The keypoints are acquired from each block. The keypoints are taken as representative points in the video image and configured for matching of the same objects between the plurality of video images subsequently.

Specifically, the common keypoint algorithms include an SIFT algorithm, an SURF algorithm, an ORB algorithm, etc. The keypoint algorithm of the video image consists of keypoint location (Keypoint Location) and descriptor generation (Descriptor Generation). The keypoint location indicates that a position (i.e. coordinates) of the keypoint in the video image is acquired from the video image through a definition of the keypoint algorithm, and some crucial information having a direction and scale may also be acquired. The descriptor generation indicates that a descriptor is generated for each keypoint located. A result of the descriptor is generally a multidimensional vector designed according to an artificial algorithm. The descriptor is configured to describe information of pixels around the keypoint, which is equivalent to provision of an independent identifier for the keypoint, so as to identify the keypoint or distinguish between different keypoints. During keypoint matching, the descriptors are compared with each other for matching according to keypoint descriptors generated according to positions of the keypoints acquired.

In the embodiment, extracting the keypoints through the ORB algorithm is described as an example.

The keypoint acquisition module 503 includes: the initial keypoint generation unit 5031 configured to generate the initial keypoints of the block.

The initial keypoints of the block are generated and configured to extract final keypoints from the block subsequently.

In the embodiment, the initial keypoints of the block are generated through an FAST algorithm, where a detection threshold in the FAST algorithm includes a high threshold and a low threshold.

The features from accelerated segment test (Features from accelerated segment test, FAST) algorithm is an algorithm configured to detect the corner point. The principle of the algorithm is to take a detection point from an image and determine whether the detection point is the corner point through pixel points in a neighborhood around the point that serves as a center of a circle. In other words, if a particular number of pixels around one pixel have pixel values different from that of the point, the point is deemed as the corner point, i.e., the initial keypoint.

It should be noted that the detection threshold in the FAST algorithm includes the high threshold and the low threshold, which indicates that the detection threshold in the FAST algorithm includes two thresholds, and a larger value and a smaller value of the two thresholds are the high threshold and the low threshold respectively.

Specifically, in the embodiment, the block is detected through the FAST algorithm, and the pixel point having a difference between gray values of various pixel points around the pixel point and a gray value of the pixel point greater than or equal to the detection threshold is generated as the initial keypoint. Correspondingly, the detection threshold is a gray difference, the high threshold means a larger gray difference, and the low threshold means a smaller gray difference.

The initial keypoints of the block are generated through the FAST algorithm, where the detection threshold in the FAST algorithm includes the high threshold and the low threshold. Therefore, when not being generated from the texture-deficient region of the video image based on the high threshold, the initial keypoints may still be generated based on the low threshold. Generation of the initial keypoints correspondingly affects a number and location of the final keypoints. In extraction of the keypoints, if the keypoints extracted are concentrated in the texture-sufficient region or feature-strong region only, for one block, one keypoint may be enough to clearly express one region, and remaining keypoints are redundant, so that unnecessary waste and cost increase are likely to be caused. However, for the texture-deficient region that lacks keypoints to describe information of the block, globally, all the keypoints are distributed unevenly. Therefore, the detection threshold in the FAST algorithm includes the high threshold and the low threshold. The situation that the keypoints finally extracted are concentrated in the texture-sufficient region or feature-strong region, while few or no keypoint exists in the texture-deficient region laving features is avoided as much as possible accordingly. Extraction of the keypoints from the texture-deficient region is significantly improved, so that the keypoints of the current video image are distributed more evenly.

Specifically, in the embodiment, the step that the initial keypoints of the block are generated through an FAST algorithm includes: simultaneous detection is performed on the block based on the high threshold and the low threshold.

It should be noted that the simultaneous detection is performed on the block based on the high threshold and the low threshold, which indicates that the block is detected based on the high threshold and the low threshold simultaneously.

In a case that simultaneous detection is performed on the block based on the high threshold and the low threshold, it is not required to detect all the blocks twice. Each block is detected based on the high threshold and the low threshold by detecting all the blocks only once. Therefore, efficiency of generating the initial keypoints is improved.

In the embodiment, in a case that the initial keypoint are detected based on the high threshold, detection based on the low threshold is stopped, and the initial keypoints detected based on the high threshold are acquired.

In a case that the initial keypoints are detected based on the high threshold, the detection based on the low threshold is stopped. Therefore, a step of repeatedly reading a content of the same block is avoided, unnecessary computation is reduced in real time, detection efficiency is improved, and a detection cost is reduced.

In the embodiment, in a case that no initial keypoints are detected based on the high threshold, and the initial keypoints are detected based on the low threshold, the initial keypoints detected based on the low threshold are acquired.

In a case that no initial keypoints are detected based on the high threshold, and the initial keypoints are detected based on the low threshold, in other words, in a case that the block has deficient texture, detection based on the low threshold may still be performed in real time to acquire the initial keypoints.

In the embodiment, in a case that no initial keypoints are detected based on the high threshold and the low threshold, the step that keypoints are acquired from the block is skipped.

In a case that no initial keypoints are detected based on the high threshold and the low threshold, in other words, in a case that the feature of the block is too unapparent, it is not required to extract the keypoints, so that the step that keypoints are acquired from the block is skipped directly, saving on a computation effort.

The keypoint acquisition module 503 further includes: the keypoint extraction unit 5032 configured to extract the initial keypoints in combination with a keypoint acquisition condition in a previous video image, so as to acquire the keypoints of the block.

The step that the initial keypoints are extracted in combination with a keypoint acquisition condition in a previous video image, so as to acquire the keypoints of the block indicates an inter-frame keypoint allocation algorithm.

In the embodiment, in a video image sequence, two adjacent video images have a high correlation. Therefore, in a case that the initial keypoints are extracted in combination with a keypoint acquisition condition in a previous video image, so as to acquire the keypoints of the block, extraction of the initial keypoints is processed in real time according to an actual situation of the video image, so as to acquire the keypoints matching an actual image feature condition of the video image. Accordingly, the keypoints of the current video image are detected accurately.

In the embodiment, the step that the initial keypoints are extracted in combination with a keypoint acquisition condition in a previous video image, so as to acquire the keypoints of the block includes: according to keypoint acquisition information of a block in the previous video corresponding to a current block, an estimated number of keypoints of the current block is acquired.

The estimated number of keypoints of the current block is acquired and taken as a reference for acquiring actual keypoints from the current block. Moreover, according to the keypoint acquisition information of the block in the previous video image corresponding to the current block, the estimated number of keypoints matching the actual image feature condition of the video image is acquired according to the actual situation of the video image.

Specifically the step that according to keypoint acquisition information of a block in the previous video image corresponding to a current block, an estimated number of keypoints of the current block is acquired includes: the block in the previous video image corresponding to the current block is acquired as a reference block.

The reference block is taken as a basis for acquiring the estimated number of keypoints of the current block.

In the embodiment, a block in a neighborhood of the reference block is acquired from the previous video image as a surrounding block.

The surrounding block and the reference block are jointly taken as the basis for acquiring the estimated number of keypoints of the current block.

In the embodiment, in a case that a block in a neighborhood of the reference block is acquired from the previous video image as a surrounding block, a neighborhood range of the reference block is set according to a global motion vector of the previous video image, where a size of the global motion vector is directly proportional to a size of the neighborhood range.

It should be noted that the size of the global motion vector is directly proportional to the size of the neighborhood range, which indicates that the greater the global motion vector is, the wider the neighborhood range set is, and the smaller the global motion vector is, the narrower the neighborhood range set is.

The global motion vector (Global Motion Vector, GMV) indicates a motion speed of the previous video image. The greater the global motion vector is, the higher the motion speed of the previous video image is, the greater the image change is, and reference may be made to a wider range. The smaller the global motion vector is, the lower the motion speed of the previous video image is, the smaller the image change is, and reference may be made to a narrower range. Therefore, the size of the global motion vector is directly proportional to the size of the neighborhood range.

As an example, in a case of a large global motion vector, 24 surrounding blocks in the neighborhood of the reference block are selected as the reference blocks. In a case of a small global motion vector, 8 surrounding blocks in the neighborhood of the reference block are selected as the reference blocks.

In the embodiment, the estimated number of keypoints of the current block is acquired in combination with keypoint acquisition information of the reference block and keypoint acquisition information of the surrounding block.

If there is a particular spatial correlation in the video image, the keypoint acquisition information of the surrounding block also affects the estimated number of keypoints of the current block. Therefore, the estimated number of keypoints of the current block is acquired in combination with the keypoint acquisition information of the reference block and the keypoint acquisition information of the surrounding block.

In the embodiment, the step that the estimated number of keypoints of the current block is acquired in combination with keypoint acquisition information of the reference block and keypoint acquisition information of the surrounding block includes: the block of the current video image is graded in combination with the keypoint acquisition information of the reference block and the keypoint acquisition information of the surrounding block, so as to obtain a grade corresponding to each block, where each grade has a corresponding estimated number.

By grading the block of the current video image, all the blocks of the current video image may be classified, blocks having similar features may be divided into the same class, and the same estimated number may be assigned to the blocks of the same class. Therefore, the estimated numbers of all the blocks are acquired simultaneously, and it is not required to assign the estimated number to each block separately. Accordingly, a number for assigning the corresponding estimated number to the block is reduced, computation efficiency is improved, and a computation cost is reduced.

Correspondingly, in the embodiment, the estimated number of keypoints of each block is acquired according to the grade corresponding to each block.

In the embodiment, the step that the estimated number of keypoints of the current block is acquired in combination with keypoint acquisition information of the reference block and keypoint acquisition information of the surrounding block includes: a condition that whether the reference block has keypoints is acquired as first information.

The condition that whether the reference block has keypoint indicates a texture condition of the reference block, and a texture condition of the current block of the current video image may be fed back correspondingly.

In the embodiment, in a case that the initial keypoints of the reference block are generated through the FAST algorithm, a condition that whether the detection threshold is the high threshold or the low threshold is acquired as second information.

In a case that the initial keypoints of the reference block are generated through the FAST algorithm, the condition that whether the detection threshold is the high threshold or the low threshold further finely indicates the texture condition of the reference block. Correspondingly, the texture condition of the current block of the current video image may be further finely fed back.

In the embodiment, a condition that whether a number of the surrounding block having keypoints is greater than or equal to a set threshold is acquired as third information.

The condition that whether a number of the surrounding block having keypoints is greater than or equal to a set threshold is acquired, which indicates that some blocks in the surrounding blocks may have no keypoints, some blocks have keypoints, and whether the number of the surrounding blocks having keypoints is greater than or equal to the set threshold is acquired.

The condition that whether a number of the surrounding block having keypoints is greater than or equal to a set threshold indicates a texture distribution condition of the surrounding block. Correspondingly, a texture distribution condition around the current block of the current video image may be fed back.

In the embodiment, in a case that the condition that whether a number of the surrounding block having keypoints is greater than or equal to a set threshold is acquired, the set threshold is half of a total number of the surrounding block.

The set threshold is half of the total number of the surrounding block. In other words, whether the number of the surrounding block having keypoints exceeds half is acquired. If the number exceeds half, it indicates that the surrounding block has strong texture. If the number does not exceed half, it indicates that the surrounding block has deficient texture.

In the embodiment, the estimated number of keypoints of the current block is acquired in combination with the first information, the second information, and the third information.

The estimated number of keypoints of the current block is acquired in combination with the first information, the second information, and the third information. Therefore, all factors affecting distribution of the keypoints of the current block are comprehensively considered, so as to acquire the accurate estimated number of the keypoints.

In the embodiment, a corresponding number of the initial keypoints are extracted according to the estimated number of keypoints of the current block as the keypoints of the block.

The corresponding number of the initial keypoints are extracted according to the estimated number of keypoints of the current block. Therefore, the keypoints matching actual texture distribution of the current video image are acquired.

In the embodiment, the step that a corresponding number of the initial keypoints are extracted according to the estimated number of keypoints of the current block as the keypoints of the block includes: a keypoint number adjustment value of the current block is acquired according to a number of keypoints of all blocks before the current block and the estimated number of keypoints.

The step that a keypoint number adjustment value of the current block is acquired according to a number of keypoints of all blocks before the current block and the estimated number of keypoints indicates an intra-frame keypoint matching algorithm.

In a process of extracting the initial keypoints to acquire the keypoints, if a number of initial keypoints actually produced from each block may not match the estimated number of keypoints, especially if the number of initial keypoints actually produced is less than the estimated number of keypoints, it may be difficult to extract a sufficient number of initial keypoints from the block as the keypoints, so that the keypoints of the current video image are in deficit finally. Therefore, the keypoint number adjustment value of the current block is acquired according to the number of keypoints of all the blocks before the current block and the estimated number of keypoints, and is configured to adjust the number of keypoints of the current block and a number of keypoints of blocks to be processed subsequently. Accordingly, a probability that the keypoints of the current video image are in deficit finally is reduced.

In the embodiment, the step that a keypoint number adjustment value of the current block is acquired according to a number of keypoints of all blocks before the current block and the estimated number of keypoints includes: a selection mode for acquiring the keypoint number adjustment value of the current block is set according to a keypoint distribution condition of the previous video image, where the selection mode includes an even allocation mode or a greedy acquisition mode.

The keypoint distribution condition of the previous video image feeds back a keypoint distribution condition of the current video image to a certain extent. Accordingly, by setting the selection mode for acquiring the keypoint number adjustment value of the current block according to the keypoint distribution condition of the previous video, the selection mode conforming to the actual texture condition of the current video image may be acquired.

The even allocation mode indicates that the adjustment value is evenly assigned to the current block and other blocks to be processed subsequently. The greedy acquisition mode indicates that for the current block and other blocks to be processed subsequently, a larger adjustment value is assigned to the block having more sufficient texture, i.e., stronger features, and a smaller adjustment value is assigned to the block having more deficient texture, i.e., weaker features.

Correspondingly, in the embodiment, the keypoint number adjustment value of the current block is acquired according to the selection mode.

In the embodiment, the step that a selection mode for acquiring the keypoint number adjustment value of the current block is set according to a keypoint distribution condition of the previous video image includes: whether the keypoints of the previous video image are distributed evenly is determined.

Whether the keypoints of the previous frame video image are distributed evenly indicates whether the keypoints of the current video image are distributed evenly. Therefore, the selection mode for acquiring the keypoint number adjustment value of the current block is set according to whether the keypoints of the previous video image are distributed evenly.

In the embodiment, the selection mode for acquiring the keypoint number adjustment value of the current block is set as the even allocation mode in a case that the keypoints of the previous video image are distributed evenly.

In a case that the keypoints of the previous video image are distributed evenly, it indicates that the keypoints of the current video image are distributed evenly, so that the number of the initial keypoints extracted may be adjusted evenly in the even allocation mode.

In the embodiment, the selection mode for acquiring the keypoint number adjustment value of the current block is set as the greedy acquisition mode otherwise.

Otherwise, it indicates that the keypoints of the current video image are distributed unevenly, so that the greedy acquisition mode is employed to fill some regions where the keypoints are distributed unevenly, and the number of the initial keypoints extracted may be adjusted evenly.

In the embodiment, the step that whether keypoints of the previous video image are distributed evenly is determined includes: the previous video image is divided one or more times, and two sub-regions having the same area are acquired during each division.

The previous video image is divided one or more times, and the two sub-regions having the same area are acquired during each division, so that all the sub-regions have the same area. In the embodiment, even distribution indicates that numbers of keypoints in all the sub-regions are as same as possible.

As an example, as shown in FIG. 6, the previous video image undergoes five divisions, including upper-lower even division shown in FIG. 6 (a), left-right even division shown in FIG. 6 (b), upper left-lower right even division shown in FIG. 6 (c), upper right-lower left even division shown in FIG. 6 (d), and inner circle-outer circle even division shown in FIG. 6 (e), so as to acquire ten sub-regions having the same area.

In the embodiment, a variance of numbers of keypoints in a plurality of sub-regions acquired during all divisions is acquired.

As an example, a variance of numbers of keypoints in the ten sub-regions is acquired to indicate a degree of dispersion between the keypoints in the ten sub-regions and an average.

In the embodiment, the sum of the numbers of keypoints in a plurality of sub-regions acquired during all divisions is acquired.

As one example, the sum of the number of keypoints in the ten sub-regions is acquired.

In the embodiment, a ratio of the variance to the sum is acquired.

As an example, a ratio of the variance to the sum of the numbers of keypoints in the ten sub-regions is acquired to indicate a degree of evenness of the keypoints in the ten sub-regions.

It can be seen that the smaller the variance is, the greater the sum of the numbers of keypoints in the plurality of sub-regions is, the smaller the ratio of the variance to the sum is, and the more even the distribution of the keypoints of the previous video image is.

Correspondingly, in the embodiment, when the ratio of the variance to the sum is less than or equal to an evenness threshold, it is determined that the keypoints of the previous video image are distributed evenly. When the ratio of the variance to the sum is greater than an evenness threshold, it is determined that the keypoints of the previous video image are distributed unevenly.

In the embodiment, in a case that the selection mode for acquiring the keypoint number adjustment value of the current block is set as the even allocation mode, the step that the keypoint number adjustment value of the current block is acquired according to the selection mode includes: a difference between the sum of estimated numbers of keypoints of all the blocks before the current block and the sum of the keypoints is acquired as a deviation value.

In the process of extracting the initial keypoints to acquire the keypoints, if the number of initial keypoints actually generated is less than the estimated number of keypoints, it is difficult to extract a sufficient number of initial keypoints from the block as the keypoints, and the keypoints of some blocks before the current block are in deficit. Therefore, the difference between the sum of the estimated numbers of keypoints of all the blocks before the current block and the sum of the keypoints, i.e. a total number of keypoints in deficit of all the blocks before the current block is acquired and configured to be evenly allocated to the current block and all the blocks after the current block. A pre-allocated solution is re-optimized dynamically within the frame according to an actual situation, so that the number of the initial keypoints extracted further satisfies demands.

In the embodiment, a number of the current block and a block number of all blocks after the current block are acquired.

The number of the current block and the block number of all blocks after the current block are acquired as the total number of the blocks to be evenly allocated the keypoints in deficit of all the blocks before the current block.

In the embodiment, a ratio of the deviation value to the block number is taken as the keypoint number adjustment value of the current block.

With the ratio of the deviation value to the block number as the keypoint number adjustment value of the current block, all the blocks after the current block are adjusted evenly.

In the embodiment, in a case of setting the selection mode for acquiring the keypoint number adjustment value of the current block as the greedy acquisition mode, the step that the keypoint number adjustment value of the current block is acquired according to the selection mode includes: a difference between the sum of estimated numbers of keypoints of all the blocks before the current block and the sum of the keypoints is acquired as a deviation value.

The description of the deviation value is the same as that for the even allocation mode, which will not be repeated herein.

In the embodiment, with a ratio of the preset number to the block number of the current video image as a number threshold, a difference between the number threshold and the estimated number of keypoints of the current block is acquired as the keypoint number adjustment value of the current block in a case that the estimated number of keypoints of the current block is less than the number threshold and the estimated number of keypoints of the current block is less than a number of the initial keypoints.

The ratio of the preset number to the block number of the current video image is a preset average number of keypoints of each block, i.e., the number threshold. In a case that the estimated number of keypoints of the current block is less than the number threshold and the estimated number of keypoints of the current block is less than a number of the initial keypoints, it indicates that the current block has apparent features, and there are initial keypoints left for selection. Therefore, a larger keypoint adjustment value is allocated to the current block as much as possible. Specifically, the difference between the number threshold and the estimated number of keypoints of the current block is acquired as the keypoint number adjustment value of the current block. Accordingly, the operation is simple and the allocation tends to be even.

In the embodiment, the keypoint number adjustment value of the current block is acquired as 0 in a case that the estimated number of keypoints of the current block is greater than or equal to the number threshold, and alternatively, the estimated number of keypoints of the current block is less than the number threshold and the estimated number of keypoints of the current block is greater than or equal to a number of the initial keypoints.

In a case that the estimated number of keypoints of the current block is greater than or equal to the number threshold, it indicates that the features of the current block are not sufficiently apparent to allow for allocation of more keypoints, so that the keypoint number adjustment value of the current block is acquired as 0. Alternatively, in a case that the estimated number of keypoints of the current block is less than the number threshold and the estimated number of keypoints of the current block is greater than or equal to a number of the initial keypoints, it indicates that the current block has no initial keypoints left for selection, so that the keypoint number adjustment value of the current block is acquired as 0.

In the embodiment, a target number of keypoints of the current block is acquired in combination with the keypoint number adjustment value and the estimated number of keypoints of the current block.

The number of the initial keypoints to be extracted from the current block is adjusted in combination with the keypoint number adjustment value and the estimated number of keypoints of the current block, so as to acquire the target number of keypoints of the current block. Therefore, the keypoints of the current video image are distributed more evenly.

Specifically, in the embodiment, the step that a target number of keypoints of the current block is acquired in combination with the keypoints number adjustment value and the estimated number of keypoints of the current block includes: the sum of the keypoint number adjustment value and the estimated number of keypoints of the current block is acquired as the target number of keypoints of the current block.

In the embodiment, the initial keypoints are extracted as the keypoints of the block according to the target number.

The initial keypoints are extracted as the keypoints of the block according to the target number, and the keypoints distributed evenly of the current video image may be acquired.

In the embodiment, the step that the initial keypoints are extracted as the keypoints of the block according to the target number includes: the initial keypoints in a number equal to the target number are extracted as the keypoints of the block in a case that the target number of keypoints of the current block is less than or equal to the number of the initial keypoints.

The initial keypoints in a number equal to the target number are extracted in a case that the target number of keypoints of the current block is less than or equal to the number of the initial keypoints, so as to satisfy detection demands.

In the embodiment, all initial keypoints are extracted as the keypoints of the block in a case that the target number of keypoints of the current block is greater than the number of the initial keypoints.

In a case that the target number of keypoints of the current block is greater than the number of the initial keypoints, the current block has no initial keypoints left for selection. Therefore, all the initial keypoints are extracted as the keypoints of the block.

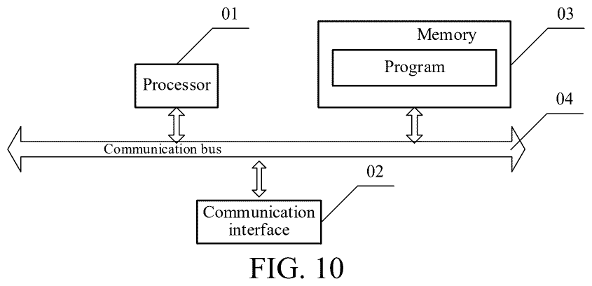

A device is further provided in an embodiment of the disclosure. By installing the above detection method for keypoints of a video image in a form of a program, the device may implement the detection method for keypoints of a video image according to the embodiment of the disclosure. An optional hardware structure of a terminal device according to the embodiment of the disclosure may be shown in FIG. 10. The terminal device includes at least one processor 01, at least one communication interface 02, at least one memory 03, and at least one communication bus 04.

In the embodiment, at least one processor 01, at least one communication interface 02, at least one memory 03, and at least one communication bus 04 are provided, and the processor 01, the communication interface 02, and the memory 03 communicate with one another through the communication bus 04. The communication interface 02 may be an interface of a communication module configured to perform network communication, such as an interface of a GSM module. The processor 01 may be a central processing unit (CPU), an application specific integrated circuit (Application Specific Integrated Circuit, ASIC), or one or more integrated circuits configured to implement the embodiment of the disclosure. The memory 03 may encompass a high-speed RAM, and may further include a non-volatile memory (non-volatile memory, NVM), such as at least one disk memory. The memory 03 stores one or more computer instructions, where the one or more computer instructions are executed by the processor 01 to implement the detection method for keypoints of a video image according to the embodiment of the disclosure.

It should be noted that the above terminal device may further include other devices (not shown) that may be unnecessary for contents disclosed in the embodiment of the disclosure. These other devices may be unnecessary for understanding the contents disclosed in the embodiment of the disclosure, and thus are not described in sequence in the embodiment of the disclosure.

A storage medium is further provided in an embodiment of the disclosure. The storage medium stores one or more computer instructions, where the one or more computer instructions are configured to implement the detection method for keypoints of a video image according to the embodiment of the disclosure.

In the embodiment of the disclosure, in a video image sequence, two adjacent video images have a high correlation. Therefore, in a case that the initial keypoints are extracted in combination with a keypoint acquisition condition in a previous video image, so as to acquire the keypoints of the block, extraction of the initial keypoints is processed in real time according to an actual situation of the video image, so as to acquire the keypoints matching an actual image feature condition of the video image. Accordingly, the keypoints of the current video image are detected accurately.

The above implementation of the disclosure indicates combinations of elements and features of the disclosure. The elements or features may be deemed optional, unless mentioned otherwise. Each element or feature may be practiced without being combined with other elements or features. Additionally, the implementation of the disclosure may be configured by combining some elements and/or features. The operation order described in the implementation of the disclosure may be re-arranged. Some configurations in any implementation may be included in another implementation, and replaced by corresponding configurations in another implementation. It will be obvious to those skilled in the art that claims having no explicit citation relationship with each other in the appended claims can be combined into the implementation of the disclosure, or included as new claims in amendments after filing of the disclosure.

The implementation of the disclosure can be implemented through various means, such as hardware, firmware, software, or their combinations. In a hardware configuration method, a method according to an illustrative implementation of the disclosure may be implemented through one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc. In a firmware or software configuration method, the implementation of the disclosure can be implemented in a form of a module, a process, a function, etc. Software codes can be stored in a memory unit and executed by the processor. The memory unit is positioned inside or outside the processor, and can transmit data to the processor and receive data from the processor via various known means.

The above description of the embodiments disclosed enables those skilled in the art to implement or use the disclosure. Various modifications to these embodiments will be apparent to those skilled in the art, and the general principles defined herein can be implemented in other embodiments without departing from the spirit or scope of the disclosure. Therefore, the disclosure conforms to the widest scope consistent with those of the principles and novel features disclosed herein, instead of being limited to the embodiment described herein.

Although disclosed as above, the disclosure is not limited thereto. Those skilled in the art can make various changes and modifications without departing from the spirit and scope of the disclosure. Therefore, the scope of protection of the disclosure should be subject to the scope defined in the claims.

What is claimed is:

1. A detection method for keypoints of a video image, comprising:
acquiring a current video image;
dividing the current video image into a plurality of blocks; and
acquiring keypoints from each block in sequence;
wherein acquiring keypoints comprises:
generating initial keypoints of the block; and
extracting the initial keypoints in combination with a keypoint acquisition condition in a previous video image, so as to acquire the keypoints of the block,
wherein the method is performed by at least one processor.

2. The detection method for keypoints of a video image according to claim 1, wherein in a case of the dividing the current video image into a plurality of blocks, a size of each block divided is set according to a size of the current video image.

3. The detection method for keypoints of a video image according to claim 1, comprising: generating the initial keypoints of the block through a Features from Accelerated Segment Test (FAST) algorithm, wherein a detection threshold in the FAST algorithm comprises a high threshold and a low threshold.

4. The detection method for keypoints of a video image according to claim 3, wherein the generating the initial keypoints of the block through an FAST algorithm comprises:
performing simultaneous detection on the block based on the high threshold and the low threshold;
stopping, in a case that the initial keypoints are detected based on the high threshold, detection based on the low threshold, and acquiring the initial keypoints detected based on the high threshold;
acquiring, in a case that no initial keypoints are detected based on the high threshold and the initial keypoints are detected based on the low threshold, the initial keypoints detected based on the low threshold; and
skipping the acquiring keypoints from the block in a case that no initial keypoints are detected based on the high threshold and the low threshold.

5. The detection method for keypoints of a video image according to claim 1, wherein the extracting the initial keypoints in combination with a keypoint acquisition condition in a previous video image, so as to acquire the keypoints of the block comprises: acquiring, according to keypoint acquisition information of a block in the previous video image corresponding to a current block, an estimated number of keypoints of the current block; and
extracting a corresponding number of the initial keypoints according to the estimated number of keypoints of the current block as the keypoints of the block.

6. The detection method for keypoints of a video image according to claim 5, wherein the acquiring, according to keypoint acquisition information of a block in the previous video image corresponding to a current block, an estimated number of keypoints of the current block comprises:
acquiring the block in the previous video image corresponding to the current block as a reference block;
acquiring a block in a neighborhood of the reference block from the previous video image as a surrounding block; and
acquiring the estimated number of keypoints of the current block in combination with keypoint acquisition information of the reference block and keypoint acquisition information of the surrounding block.

7. The detection method for keypoints of a video image according to claim 6, wherein in a case of the acquiring a block in a neighborhood of the reference block from the previous video image as a surrounding block, a neighborhood range of the reference block is set according to a global motion vector of the previous video image, wherein a size of the global motion vector is directly proportional to a size of the neighborhood range.

8. The detection method for keypoints of a video image according to claim 6, wherein the acquiring the estimated number of keypoints of the current block in combination with keypoint acquisition information of the reference block and keypoint acquisition information of the surrounding block comprises: grading the block of the current video image in combination with the keypoint acquisition information of the reference block and the keypoint acquisition information of the surrounding block, so as to obtain a grade corresponding to each block, wherein each grade has a corresponding estimated number; and
acquiring an estimated number of keypoints of each block according to the grade corresponding to each block.

9. The detection method for keypoints of a video image according to claim 6, comprising:
generating the initial keypoints of the block through a Features From Accelerated Segment Test (FAST) algorithm, wherein a detection threshold in the FAST algorithm comprises a high threshold and a low threshold; and
wherein the acquiring the estimated number of keypoints of the current block in combination with keypoint acquisition information of the reference block and keypoint acquisition information of the surrounding block comprises:
acquiring a condition that whether the reference block has keypoints as first information;
acquiring a condition that whether the detection threshold is the high threshold or the low threshold in a case that initial keypoints of the reference block are generated through the FAST algorithm as second information;
acquiring a condition that whether a number of the surrounding block having keypoints is greater than or equal to a set threshold as third information; and
acquiring the estimated number of keypoints of the current block in combination with the first information, the second information, and the third information.

10. The detection method for keypoints of a video image according to claim 9, wherein in a case of the acquiring a condition that whether a number of the surrounding block having keypoints is greater than or equal to a set threshold, the set threshold is half of a total number of the surrounding block.

11. The detection method for keypoints of a video image according to claim 5, wherein the extracting a corresponding number of the initial keypoints according to the estimated number of keypoints of the current block as the keypoints of the block comprises:
acquiring a keypoint number adjustment value of the current block according to a number of keypoints of all blocks before the current block and the estimated number of keypoints;
acquiring a target number of keypoints of the current block in combination with the keypoint number adjustment value and the estimated number of keypoints of the current block; and
extracting the initial keypoints as the keypoints of the block according to the target number.

12. The detection method for keypoints of a video image according to claim 11, wherein the acquiring a keypoint number adjustment value of the current block according to a number of keypoints of all blocks before the current block and the estimated number of keypoints comprises:
setting a selection mode for acquiring the keypoint number adjustment value of the current block according to a keypoint distribution condition of the previous video image, wherein the selection mode comprises an even allocation mode or a greedy acquisition mode; and
acquiring the keypoint number adjustment value of the current block according to the selection mode.

13. The detection method for keypoints of a video image according to claim 12, wherein the setting a selection mode for acquiring the keypoint number adjustment value of the current block according to a keypoint distribution condition of the previous video image comprises:
determining whether keypoints of the previous video image are distributed evenly;
setting the selection mode for acquiring the keypoint number adjustment value of the current block as the even allocation mode in a case that the keypoints of the previous video image are distributed evenly; and
setting the selection mode for acquiring the keypoint number adjustment value of the current block as the greedy acquisition mode otherwise.

14. The detection method for keypoints of a video image according to claim 13, wherein the determining whether keypoints of the previous video image are distributed evenly comprises:
dividing the previous video image one or more times, and acquiring two sub-regions having the same area during each division;
acquiring a variance of numbers of keypoints in a plurality of sub-regions acquired during all divisions respectively;
acquiring the sum of the numbers of keypoints in the plurality of sub-regions acquired during all the divisions;
acquiring a ratio of the variance to the sum;
determining that the keypoints of the previous video image are distributed evenly in a case that the ratio of the variance to the sum is less than or equal to an evenness threshold; and
determining that the keypoints of the previous video image are distributed unevenly in a case that the ratio of the variance to the sum is greater than an evenness threshold.

15. The detection method for keypoints of a video image according to claim 13, wherein in a case of setting the selection mode for acquiring the keypoint number adjustment value of the current block as the even allocation mode, the acquiring the keypoint number adjustment value of the current block according to the selection mode comprises: acquiring a difference between the sum of estimated numbers of the keypoints of all the blocks before the current block and the sum of the keypoints as a deviation value;
acquiring a number of the current block and a block number of all blocks after the current block; and
taking a ratio of the deviation value to the block number as the keypoint number adjustment value of the current block.

16. The detection method for keypoints of a video image according to claim 13, wherein in a case of the acquiring a current video image, the video image is set to have a preset number of keypoints; and
in a case of setting the selection mode for acquiring the keypoint number adjustment value of the current block as the greedy acquisition mode, the acquiring the keypoint number adjustment value of the current block according to the selection mode comprises:
acquiring a difference between the sum of estimated numbers of keypoints of all the blocks before the current block and the sum of the keypoints as a deviation value;
taking a ratio of the preset number to a block number of the current video image as a number threshold, and acquiring a difference between the number threshold and the estimated number of keypoints of the current block as the keypoint number adjustment value of the current block in a case that the estimated number of keypoints of the current block is less than the number threshold and the estimated number of keypoints of the current block is less than a number of the initial keypoints; and
acquiring the keypoint number adjustment value of the current block as 0 in a case that the estimated number of keypoints of the current block is greater than or equal to the number threshold, and alternatively, the estimated number of keypoints of the current block is less than the number threshold and the estimated number of keypoints of the current block is greater than or equal to a number of the initial keypoints.

17. The detection method for keypoints of a video image according to claim 11, wherein the acquiring a target number of keypoints of the current block in combination with the keypoint number adjustment value and the estimated number of keypoints of the current block comprises: acquiring the sum of the keypoint number adjustment value and the estimated number of keypoints of the current block as the target number of keypoints of the current block.

18. The detection method for keypoints of a video image according to claim 11, wherein the extracting the initial keypoints as the keypoints of the block according to the target number comprises: extracting the initial keypoints in a number equal to the target number as the keypoints of the block in a case that the target number of keypoints of the current block is less than or equal to a number of the initial keypoints; and
extracting all initial keypoints as the keypoints of the block in a case that the target number of keypoints of the current block is greater than a number of the initial keypoints.

19. A device, comprising at least one memory and at least one processor, wherein the at least one memory stores one or more computer instructions that, when executed by the at least one processor, cause the at least one processor to implement the detection method for keypoints of a video image according to claim 1.

20. A non-transitory storage medium storing one or more computer instructions, wherein the one or more computer instructions are configured to cause at least one processor to implement the detection method for keypoints of a video image according to f claim 1.
